(19) United States
(12) Patent Application Publication
(10) Pub. No.: US 2024/0430618 A1
(43) Pub. Date: Dec. 26, 2024

(54) ELECTRONIC DEVICE HAVING MULTIPLE SPEAKERS CONTROLLED BY A SINGLE FUNCTIONAL CHIP

(71) Applicant: Richtek Technology Corp., Hsinchu County (TW)

(72) Inventors: Tsung-Han Yang, Kaohsiung City (TW); Yen-Chih Wang, New Taipei City (TW); Ming-Jun Hsiao, Hsinchu County (TW); Tsung-Nan Wu, Hsinchu County (TW)

(21) Appl. No.: 18/827,834

(22) Filed: Sep. 8, 2024

Related U.S. Application Data
(62) Division of application No. 18/079,011, filed on Dec. 12, 2022, now Pat. No. 12,143,786.

(30) Foreign Application Priority Data
Nov. 4, 2022 (TW) 111142247

(51) Int. Cl. H04R 3/12; H04R 1/24; H04R 3/04; H04R 5/04

(52) U.S. Cl. CPC H04R 3/12; H04R 1/24; H04R 3/04; H04R 5/04

(57) ABSTRACT

An electronic device includes two speakers, a single functional chip, a parameter extraction circuit, an audio processing module, a gain adjusting circuit and a current detecting unit. The current detecting unit is disposed in the functional chip for detecting the driving current of the two speakers. The functional chip provides the driving voltage of the two speakers based on an output signal and converts the analogue current/voltages of the two speakers into digital current/voltages. The parameter extraction circuit acquires the parameter of each speaker based on the digital current/voltages. The audio processing module acquires the gains of various physical quantities based on the parameter of each speaker and determines the final gain of each physical quantity. The gain adjusting circuit provides the output signal by adjusting the gain of an input signal based on the final gain of each physical quantity.

### CROSS REFERENCE TO RELATED APPLICATIONS

This application is a division of U.S. application Ser. No. 18/079,011, filed on Dec. 12, 2022. The content of the application is incorporated herein by reference.

### BACKGROUND OF THE INVENTION

### 1. Field of the Invention

The present invention is related to an electronic device having multiple speakers controlled by a single functional chip, and more particularly, to an electronic device having multiple speakers controlled by a single functional chip and capable of optimizing the performance of each speaker and providing individual protection for each speaker.

### 2. Description of the Prior Art

A speaker is an electronic device capable of converting electrical signals into audio signals and normally includes diaphragms and a control circuit made of electromagnets and coils. When the current of the speaker control signal corresponding to a specific frequency flows through the coils in the speaker, the coils vibrate in the same frequency of the current. The diaphragms attached to the coils also start to vibrate, thereby causing disturbance in surrounding air for producing sound. The speaker control signal may be provided by a smart audio amplifier chip which adopts protective algorithms to ensure that each physical quantity of the speaker during operation (such as temperature, voltage, current or excursion) is within its nominal range, thereby allowing the speaker to operate safely.

An electronic device may adopt multiple speakers to provide sufficient sound effects in certain applications. When a single functional chip is used to control multiple speakers, the protective algorithm can only be executed according to the total current and the total voltage of the multiple speakers. In other words, since the prior art functional chip is unable to acquire the physical quantity of each speaker during operation based on the individual current and the individual voltage of each speaker, it fails to provide individual protection for each speaker.

Therefore, in an electronic device having multiple speakers controlled by a single functional chip, there is a need to optimize the performance of each speaker and provide individual protection for each speaker.

### SUMMARY OF THE INVENTION

The present invention provides an electronic device having multiple speakers controlled by a single functional chip. The electronic device includes a first speaker, a second speaker, the single functional chip having an amplifier, a first current-sensing unit and first through third analog-to-digital converters, a second current-sensing unit and a controller having a judging circuit, a parameter extraction circuit and an audio processing module. The first speaker is configured to operate according to a driving voltage. The second speaker is coupled in parallel with the first speaker and configured to operate according to the driving voltage. The amplifier is configured to convert an output signal into the driving voltage. The first current-sensing unit is configured to detect a driving current which is equal to a sum of a first current flowing through the first speaker and a second current flowing through the second speaker. The first analog-to-digital converter is coupled to the first current-sensing unit and configured to convert the driving current into a first signal. The second analog-to-digital converter is configured to convert the second current into a second signal. The third analog-to-digital converter is coupled in parallel with the first speaker and configured to convert the driving voltage into a third signal. The second current-sensing unit is coupled to the second speaker and configured to detect the second current flowing through the second speaker. The judging circuit is coupled to the first analog-to-digital converter for receiving the first signal and coupled to the second analog-to-digital converter for receiving the second signal, and configured to provide a fourth signal associated with the first current flowing through the first speaker by acquiring a difference between the first signal and the second signal. The parameter extraction circuit is configured to acquire at least one first parameter of the first speaker and at least one second parameter of the second speaker based on the second signal, the third signal and the fourth signal. The audio processing module is configured to receive an input signal, adjust a gain of the input signal based on the at least one first parameter and the at least one second parameter, and provide the output signal by amplifying the input signal with the gain.

The present invention also provides an electronic device having multiple speakers controlled by a single functional chip. The electronic device includes a first speaker, a second speaker, the single functional chip having an amplifier, a current-sensing unit and first through third analog-to-digital converters, and a controller having a judging circuit, a parameter extraction circuit and an audio processing module. The first speaker is configured to operate according to a driving voltage. The second speaker is coupled in series to the first speaker and configured to operate according to the driving voltage. The amplifier is configured to convert an output signal into the driving voltage. The current-sensing unit is configured to detect a driving current flowing through the first speaker and the second speaker. The first analog-to-digital converter is coupled in parallel with the first speaker and the second speaker and configured to convert a voltage established across the first speaker and the second speaker into a first signal. The second analog-to-digital converter is coupled in parallel with the second speaker and configured to convert a voltage established across the second speaker into a second signal. The third analog-to-digital converter is coupled to the current-sensing unit and configured to convert the driving current into a third signal. The judging circuit is coupled to the first analog-to-digital converter for receiving the first signal and coupled to the second analog-to-digital converter for receiving the second signal, and configured to provide a fourth signal associated with a voltage established across the first speaker by acquiring a difference between the first signal and the second signal. The parameter extraction circuit is configured to acquire at least one first parameter of the first speaker and at least one second parameter of the second speaker based on the second signal, the third signal and the fourth signal. The audio processing module is configured to receive an input signal, adjust a gain of the input signal based on the at least one first parameter and the at least one second parameter, and provide the output signal by amplifying the input signal with the gain.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram illustrating a functional diagram of an electronic device according to an embodiment of the present invention.

FIG. 2 is a functional diagram illustrating a functional diagram of an electronic device according to another embodiment of the present invention.

FIG. 3 is a functional diagram illustrating the temperature controller in the audio processing module of an electronic device according to an embodiment of the present invention.

FIG. 4 is a functional diagram illustrating the excursion controller in the audio processing module of an electronic device according to an embodiment of the present invention.

FIG. 5 is a functional diagram illustrating the power controller in the audio processing module of an electronic device according to an embodiment of the present invention.

### DETAILED DESCRIPTION

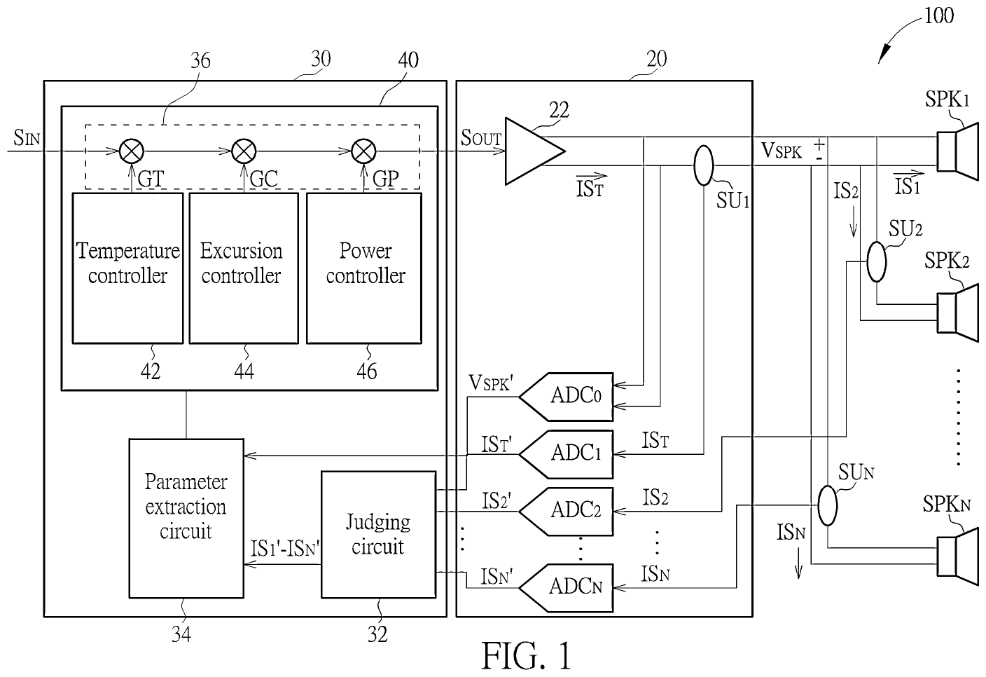

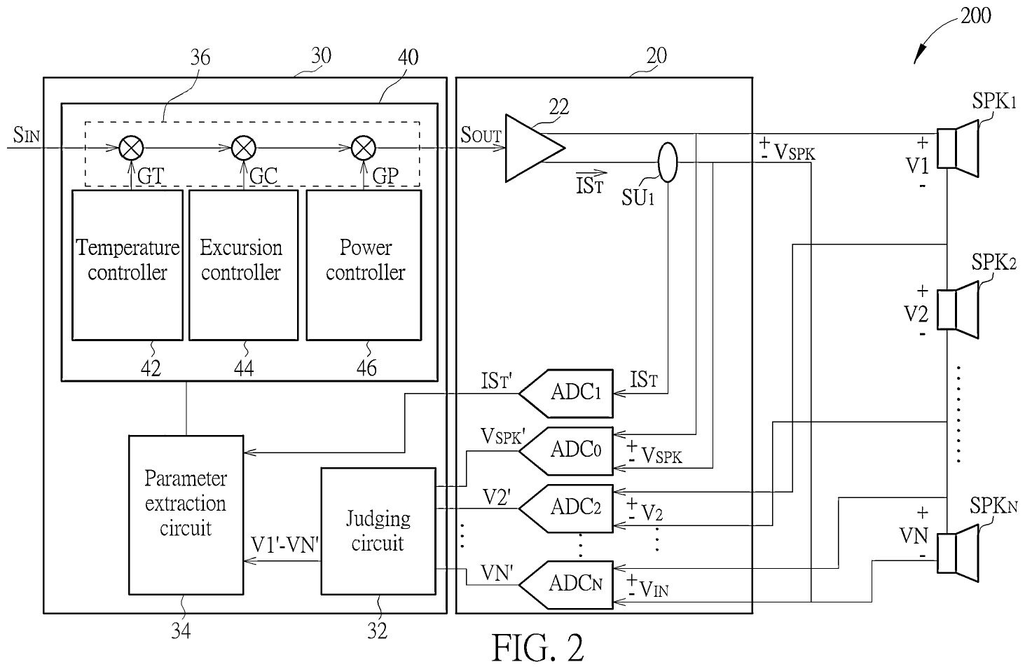

FIG. 1 is a functional diagram illustrating a functional diagram of an electronic device 100 according to an embodiment of the present invention. FIG. 2 is a functional diagram illustrating a functional diagram of an electronic device 200 according to another embodiment of the present invention. Each of the electronic devices 100 and 200 includes multiple speakers SPK₁-SPK_{N}, one or multiple current-sensing units SU₁-SU_{M}, a functional chip 20 and a controller 30, wherein N is an integer larger than 1 and M is a positive integer. For illustrative purpose, V1-VN respectively represent the voltages established across the speakers SPK₁-SPK_{N}, IS₁-IS_{N} respectively represent the current flowing through the speakers SPK₁-SPK_{N}, V_{SPK} represents the driving voltage of the speakers SPK₁-SPK_{N}, and IS_{T} represents the driving current of the speakers SPK₁-SPK_{N}.

In the present invention, the speakers SPK₁-SPK_{N} may include speakers of the same type or include different types of speakers. In an embodiment, each speaker may be a dynamic speaker, an electromagnet speaker, a piezoelectric speaker, an electrostatic speaker or a plasma speaker. In an embodiment, each speaker may be a woofer, a subwoofer, a mid-range speaker, a tweeter, a super tweeter, a coaxial speaker or a full-range speaker. However, the types of the speakers SPK₁-SPK_{N} do not limit the scope of the present invention.

In the electronic device 100 depicted in FIG. 1, the speakers SPK₁-SPK_{N} are coupled in parallel with each other, wherein the first input ends of the speakers SPK₁-SPK_{N} are coupled together and the second input ends of the speakers SPK₁-SPK_{N} are coupled together. In the parallel configuration, each speaker is configured to operate according the driving voltage V_{SPK} (V1=V2= . . . =VN=V_{SPK}). In the electronic device 100, the number of the current-sensing units SU₁-SU_{M} is equal to the number of the speakers SPK₁-SPK_{N} (M=N). The current-sensing unit SU₁ is disposed in the functional chip 20 and coupled to the speaker SPK₁, while the current-sensing units SU₂-SU_{M} are disposed outside the functional chip 20 and coupled to the speakers SPK₁-SPK_{N}, respectively. The current-sensing unit SU₁ is configured to detect the sum of the current IS₁-IS_{N} flowing through the speakers SPK₁-SPK_{N} (i.e., the driving current IS_{T}), and the current-sensing units SU₂-SU_{M} are configured to respectively detect the current IS₂-IS_{N} flowing through the speakers SPK₂-SPK_{N}, wherein IS_{T}=IS₁+IS₂+ . . . +IS_{N}.

In the electronic device 200 depicted in FIG. 2, the speakers SPK₁-SPK_{N} are coupled in a series to each other, wherein the second input end of the speaker SPK₁ is coupled to the first input end of the speaker SPK₂, the second input end of the speaker SPK₂ is coupled to the first input end of the speaker SPK₃, etc. In the series configuration, the speakers SPK₁-SPK_{N} are configured to operate according the voltages V1-VN, respectively, wherein V1+V2+ . . . +VN=V_{SPK}. The electronic device 200 includes one current-sensing unit SU₁ (M=1), wherein the current-sensing unit SU₁ is disposed in the functional chip 20 and coupled to the speaker SPK₁. The current-sensing unit SU₁ is configured to detect the sum of the current IS₁-IS_{N} flowing through the speakers SPK₁-SPK_{N} (i.e., the driving current IS_{T}), wherein IS_{T}=IS₁+IS₂+ . . . +IS_{N}.

In an embodiment of the present invention, each of the current-sensing units SU₁-SU_{M} may include a precise resistor, a capacitor and/or an inductor. However, the implementation of the current-sensing units SU₁-SU_{M} does not limit the scope of the present invention.

In the present invention, the functional chip 20 may be a smart audio amplifier chip which includes an amplifier 22, the current-sensing unit SU₁, and multiple analog-to-digital converters ADC₀-ADC_{N}. The amplifier 22 includes an input end coupled to the controller 30 for receiving an output signal S_{OUT}, a first output end coupled to the first input ends of the speakers SPK₁-SPK_{N}, and a second output end coupled to the second input ends of the speakers SPK₁-SPK_{N}. The functional chip 20 is configured to provide the driving voltage V_{SPK} for the speakers SPK₁-SPK_{N} by amplifying the output signal S_{OUT}.

In the electronic device 100 depicted in FIG. 1, the analog-to-digital converter ADC₀ is coupled to the two output ends of the amplifier 22 and configured to convert the analog driving voltage V_{SPK} into a digital driving voltage V_{SPK}′. The analog-to-digital converter ADC₁ is coupled to the current-sensing unit SU₁ and configured to convert the analog driving current IS_{T} flowing through the speakers SPK₁-SPK_{N} into a digital driving current IS_{T}′. The analog-to-digital converters ADC₂-ADC_{N} are respectively coupled to the current-sensing units SU₂-SU_{N} and configured to convert the analog current IS₂-IS_{N} flowing through the speakers SPK₂-SPK_{N} into digital current IS₂′-IS_{N}′, respectively.

In the electronic device 200 depicted in FIG. 2, the analog-to-digital converter ADC₀ is coupled to the current-sensing unit SU₁ and configured to convert the analog driving current IS_{T} into a digital driving current IS_{T}′. The analog-to-digital converter ADC₁ is coupled to the two output ends of the amplifier 22 and configured to convert the analog driving voltage V_{SPK} into a digital driving voltage V_{SPK}′. The analog-to-digital converters ADC₂-ADC_{N} are respectively coupled in parallel with the speakers SPK₂-SPK_{N} and configured to convert the analog voltages V1-VN into digital voltages V1′-VN′, respectively.

In the present invention, the controller 30 includes a judging circuit 32, a parameter extraction circuit 34, a gain-adjusting circuit 36, and an audio processing module 40. The controller 30 is configured to receive the input signal S_{IN} and provide the corresponding output signal S_{OUT} by processing the input signal S_{IN}. The judging circuit 32 is configure to acquire digital current IS₁′-IS_{N}′ or digital voltages V1′-VN′ respectively associated with the speakers SPK₁-SPK_{N} according to the data provided by the functional chip 20.

In the electronic device 100 depicted in FIG. 1, the judging circuit 32 is configured to receive the digital current IS_{T}′ and IS₂′-IS_{N}′ provided by the analog-to-digital converters ADC₁-ADC_{N} of the functional chip 20, and acquire the digital current IS₁′ associated with the analog current IS₁ flowing through the speaker SPK₁, wherein IS₁′=IS_{T}′-IS₂′- . . . -IS_{N}′. Therefore, the parameter extraction circuit 34 may be informed of the digital voltages V1′-VN′ respectively associated with the voltages established across the speakers SPK₁-SPK_{N} and the digital current IS₁′-IS_{N}′ associated with the current flowing through the speakers SPK₁-SPK_{N}.

In the electronic device 200 depicted in FIG. 2, the judging circuit 32 is configured to receive the digital voltages V_{SPK} and V2′-VN′ provided by the analog-to-digital converters ADC₁-ADC_{N} of the functional chip 20, and acquire the digital voltage V1′ associated with the speaker SPK₁, wherein V1′=V_{SPK}-V2′- . . . -VN′. Therefore, the parameter extraction circuit 34 may be informed of the digital voltages V1′-VN′ respectively associated with the analog voltages V1-VN established across the speakers SPK₁-SPK_{N} and the digital current IS₁′-IS_{N}′ associated with the current flowing through the speakers SPK₁-SPK_{N} (IS₁′=IS₂′= . . . =IS_{N}′=IS_{T}′).

In an embodiment of the present invention, the parameter extraction circuit 34 is configured to acquire the parameter of each speaker based on the digital voltages V1′-VN′ and the digital current IS₁′-IS_{N}′. The above-mentioned parameter may be the Thiele/Small (TS) parameter of each speaker, such as the direct-current (DC) impedance RDC, the resonant frequency w0, the mechanical quality factor Q_{MS}, the electrical quality factor Q_{ES}, the total quality factor Q_{TS}, or the force factor of each speaker. The force factor of a speaker is equal to a multiple of the magnet flux density of the speaker and the coil length of the speaker. Based on the above-mentioned parameter, the parameter extraction circuit 34 may acquire the impedance curve Z(s) of each speaker, depicted as follows:

$$Z ( s ) = V ( s ) / I ( s ) = {R}_{DC} * ( {s}^{2} / {w}_{0}^{2} + s / ( {Q}_{TS} * {w}_{0} ) + 1 ) / ( {s}^{2} / {w}_{0}^{2} + s / ( {Q}_{MS} * {w}_{0} ) + 1 )$$

In the present invention, the audio processing module 40 is configured to acquire the gains of various physical quantities based on the parameter of each speaker among the speakers SPK₁-SPK_{N} and determine the final gain of each physical quantity, such as the final temperature gain, the final excursion gain, and/or the final power gain.

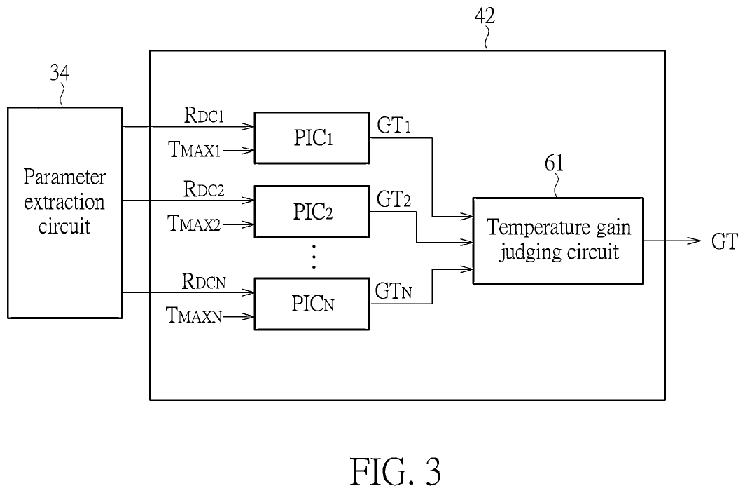

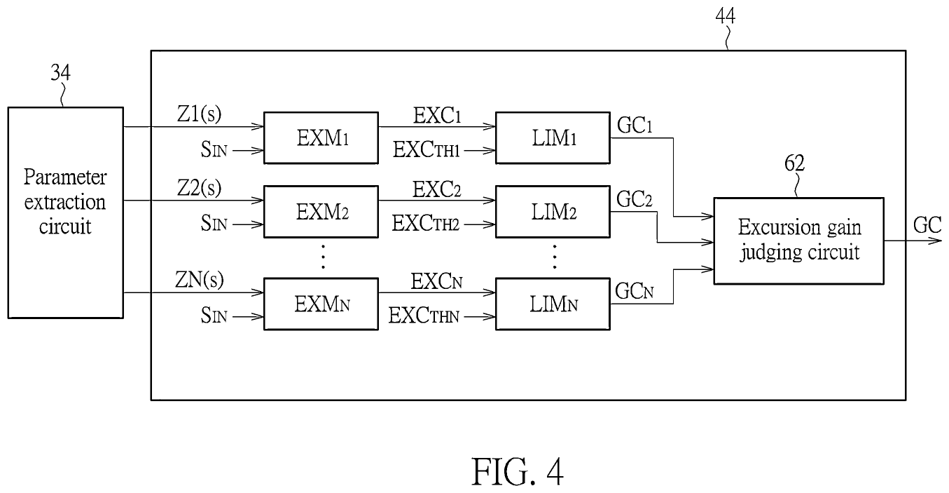

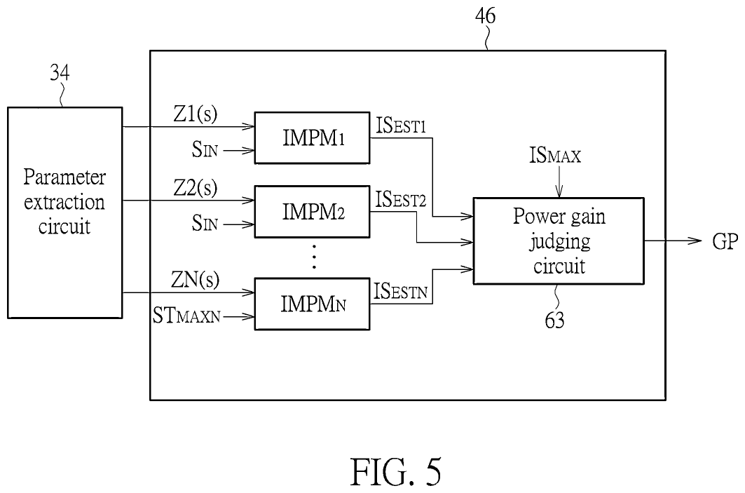

In an embodiment of the present invention, the audio processing module 40 includes a temperature controller 42, an excursion controller 44, and a power controller 46. FIG. 3 is a functional diagram illustrating the temperature controller 42 in the audio processing module 40 according to an embodiment of the present invention. FIG. 4 is a functional diagram illustrating the excursion controller 44 in the audio processing module 40 according to an embodiment of the present invention. FIG. 5 is a functional diagram illustrating the power controller 46 in the audio processing module 40 according to an embodiment of the present invention.

As depicted in FIG. 3, the temperature controller 42 includes a plurality of proportional-integral controllers PIC₁-PIC_{N} and a temperature gain judging circuit 61. The proportional-integral controllers PIC₁-PIC_{N} are configured to respectively receive the DC impedance R_{DC1}-R_{DCN} of the speakers SPK₁-SPK_{N} from the parameter extraction circuit 34 and acquire the individual temperature gains GT₁-GT_{N} of the speakers SPK₁-SPK_{N} based on the relationship between the predetermined temperature thresholds T_{MAX1}-T_{MAXN} of the speakers SPK₁-SPK_{N} under the current temperature and the DC impedance R_{DC1}-R_{DCN}. The temperature gain judging circuit 61 is configured to determine the values of the individual temperature gains GT₁-GT_{N} and output the smallest individual temperature gain as the final temperature gain GT.

As depicted in FIG. 4, the excursion controller 44 includes a plurality of excursion models EXM₁-EXM_{N} respectively associated the operation of the speakers SPK₁-SPK_{N}, a plurality of limiters LIM₁-LIM_{N}, and an excursion gain judging circuit 62. The excursion models EXM₁-EXM_{N} are configured to respectively receive the DC impedance curves Z1 (s)-ZN (s) of the speakers SPK₁-SPK_{N} from the parameter extraction circuit 34 and acquire the current excursion values EXC₁-EXC_{N} of the speakers SPK₁-SPK_{N} based on the input signal S_{IN} and the DC impedance curves Z1 (s)-ZN (s). The limiters LIM₁-LIM_{N} are configured to respectively receive the current excursion values EXC₁-EXC_{N} and acquire the individual excursion gains GC₁-GC_{N} of the speakers SPK₁-SPK_{N} based on the relationship between the predetermined excursion thresholds EXC_{TH1}-EXC_{THN} of the speakers SPK₁-SPK_{N} and the current excursion values EXC₁-EXC_{N}. The excursion gain judging circuit 62 is configured to determine the values of the individual excursion gains GC₁-GC_{N} and output the smallest individual excursion gain as the final excursion gain GC.

As depicted in FIG. 5, the power controller 46 includes a plurality of impedance models IMPM₁-IMPM_{N} respectively associated the operation of the speakers SPK₁-SPK_{N}, and an power gain judging circuit 63. The impedance models IMPM₁-IMPM_{N} are configured to respectively receive the DC impedance curves Z1 (s)-ZN (s) of the speakers SPK₁-SPK_{N} from the parameter extraction circuit 34 and acquire the current estimated current values IS_{EST1}-IS_{ESTN} of the speakers SPK₁-SPK_{N} based on the input signal S_{IN} and the DC impedance curves Z1 (s)-ZN (s). The power gain judging circuit 63 is configured to receive the current estimated current values IS_{EST1}-IS_{ESTN} of the speakers SPK₁-SPK_{N} and provide the final power gain GP according to the sum of the current estimated current values IS_{EST1}-IS_{ESTN} of the speakers SPK₁-SPK_{N}. In an embodiment, the power gain judging circuit 63 is a limiter configured to output the sum of the current estimated current values IS_{EST1}-IS_{ESTN} as the final power gain GP when the sum of the current estimated current values IS_{EST1}-IS_{ESTN} is smaller than a maximum current threshold IS_{MAX} and output the maximum current threshold IS_{MAX} as the final power gain GP when the sum of the current estimated current values IS_{EST1}-IS_{ESTN} is not smaller than the maximum current threshold IS_{MAX}.

In the present invention, the gain adjusting circuit 36 can adjust the gain of the input signal S_{IN} based on the final temperature gain GT, the final excursion gain GC, and/or the final power gain GT, thereby providing the output signal S_{OUT}.

In conclusion, in an electronic device having multiple speakers controlled by a single functional chip, the present invention can monitor the operational status of each speaker and adjust the driving voltage V_{SPK} accordingly. Therefore, the present invention can optimize the performance of each speaker and provide individual protection for each speaker.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device having multiple speakers controlled by a single functional chip, comprising:
a first speaker configured to operate according to a driving voltage;
a second speaker coupled in series to the first speaker and configured to operate according to the driving voltage;
the single functional chip, comprising:
an amplifier configured to convert an output signal into the driving voltage;
a current-sensing unit configured to detect a driving current flowing through the first speaker and the second speaker;
a first analog-to-digital converter coupled in parallel with the first speaker and the second speaker and configured to convert a voltage established across the first speaker and the second speaker into a first signal;
a second analog-to-digital converter coupled in parallel with the second speaker and configured to convert a voltage established across the second speaker into a second signal; and
a third analog-to-digital converter coupled to the current-sensing unit and configured to convert the driving current into a third signal; and
a controller, comprising:
a judging circuit coupled to the first analog-to-digital converter for receiving the first signal and coupled to the second analog-to-digital converter for receiving the second signal, and configured to provide a fourth signal associated with a voltage established across the first speaker by acquiring a difference between the first signal and the second signal; and
a parameter extraction circuit configured to acquire at least one first parameter of the first speaker and at least one second parameter of the second speaker based on the second signal, the third signal and the fourth signal; and
an audio processing module configured to:
receive an input signal;
adjust a gain of the input signal based on the at least one first parameter and the at least one second parameter; and
provide the output signal by amplifying the input signal with the gain.

2. The electronic device of claim 1, wherein:
the at least one first parameter is a first direct-current (DC) impedance, a first resonant frequency, a first mechanical quality factor, a first electrical quality factor, a first total quality factor or a first force factor of the first speaker;
the at least one second parameter is a second DC impedance, a second resonant frequency, a second mechanical quality factor, a second electrical quality factor, a second total quality factor or a second force factor of the second speaker;
the first force factor of the first speaker is equal to a multiple of a first magnet flux density of the first speaker and a first coil length of the first speaker; and
the second force factor of the second speaker is equal to a multiple of a second magnet flux density of the second speaker and a second coil length of the second speaker.

3. The electronic device of claim 1, wherein:
the at least one first parameter is a first DC impedance of the first speaker;
the at least one second parameter is a second DC impedance of the second speaker;
the audio processing module comprises a temperature controller coupled to the parameter extraction circuit for receiving the first DC impedance and the second DC impedance, and configured to:
acquire a first individual temperature gain associated with the first DC impedance and a second individual temperature gain associated with the second DC impedance;
output the first individual temperature gain as a final temperature gain when the first individual temperature gain is smaller than the second individual temperature gain; and
output the second individual temperature gain as a final temperature gain when the second individual temperature gain is smaller than the smaller individual temperature gain; and
the audio processing module is further configured to adjust the gain of the input signal based on the final temperature gain.

4. The electronic device of claim 3, wherein the temperature controller comprises:
a first proportional integral (PI) controller configured to acquire the first individual temperature gain based on the first DC impedance and a first predetermined temperature threshold associated with the first speaker; and
a second PI controller configured to acquire the second individual temperature gain based on the second DC impedance and a second predetermined temperature threshold associated with the second speaker.

5. The electronic device of claim 1, wherein:
the at least one first parameter is a first impedance curve of the first speaker;
the at least one second parameter is a second impedance curve of the second speaker;
the audio processing module comprises an excursion controller coupled to the parameter extraction circuit for receiving the first impedance curve and the second impedance curve, and configured to:
acquire a first individual excursion gain associated with the first impedance curve and a second individual excursion gain associated with the second impedance curve;
output the first individual excursion gain as a final excursion gain when the first individual excursion gain is smaller than the second individual excursion gain; and
output the second individual excursion gain as a final excursion gain when the second individual excursion gain is smaller than the smaller individual excursion gain; and
the audio processing module is further configured to adjust the gain of the input signal based on the final excursion gain.

6. The electronic device of claim 5, wherein the excursion controller comprises:
a first excursion model configured to acquire a first excursion value based on the first impedance curve and the input signal; and
a second excursion model configured to acquire a second excursion value based on the second impedance curve and the input signal.

7. The electronic device of claim 6, wherein the excursion controller further comprises:
a first limiter configured to acquire the first individual excursion gain based on the first excursion value and a first predetermined excursion threshold associated with the first speaker; and
a second limiter configured to acquire the second individual excursion gain based on the second excursion value and a second predetermined excursion threshold associated with the second speaker.

8. The electronic device of claim 1, wherein:
the at least one first parameter is a first impedance curve of the first speaker;
the at least one second parameter is a second impedance curve of the second speaker;
the audio processing module comprises a power controller coupled to the parameter extraction circuit for receiving the first impedance curve and the second impedance curve, and configured to:
acquire a first estimated current value associated with the first speaker based on the input signal and the first impedance curve;
acquire a second estimated current value associated with the second speaker based on the input signal and the second impedance curve;
output a sum of the first estimated current value and the second estimated current value as a final power gain when the sum of the first estimated current value and the second estimated current value is not larger than a maximum current threshold; and
output the maximum current threshold as the final power gain when the sum of the first estimated current value and the second estimated current value is larger than the maximum current threshold; and
the audio processing module is further configured to adjust the gain of the input signal based on the final power gain.

9. The electronic device of claim 8, wherein the power controller comprises:
a first impedance model configured to acquire the first estimated current value based on the first impedance curve and the input signal; and
a second impedance model configured to acquire the second estimated current value based on the second impedance curve and the input signal.
